(19) United States
(12) Patent Application Publication
(10) Pub. No.: US 2006/0249178 A1
(43) Pub. Date: Nov. 9, 2006

(54) Printing plate processor

(75) Inventors: Douglas Kenneth Manness, North Vancouver (CA); Matthew Albert MacLennan Harper, Vancouver (CA)

Correspondence Address: Ralph A. Dowell of DOWELL & DOWELL P.C., 2111 Eisenhower Ave, Suite 406, Alexandria, VA, 22314, US

(73) Assignee: Vectis Technologies Inc.

(21) Appl. No.: 11/122,105

(22) Filed: May 5, 2005

(51) Int. Cl. B08B 7/04

(52) U.S. Cl. 134/10; 15/77; 15/102; 15/302; 15/306.1; 15/308

(57) ABSTRACT

An apparatus for cleaning an element used in a printing plate processor is disclosed. The printing plate processor includes a container for containing a liquid used in performing the processing operation on the printing plate. The apparatus includes a cleaner located in the container, the cleaner being moveable to contact the element to be cleaned and an actuator coupled to the cleaner and operably configured to move the cleaner to contact the element to be cleaned. An apparatus for performing a processing operation on a printing plate is also disclosed. The apparatus includes a container operably configured to contain a liquid for use in performing the processing operation on the printing plate and a cover operably configured to cover a surface of the liquid in the container to reduce interaction between the liquid and an environment about the container, the cover defining an entrance opening operably configured to admit the printing plate into the liquid and an exit opening operably configured to permit the printing plate to be discharged from the liquid. The apparatus also includes an entrance seal operably configured to seal the entrance opening to reduce interaction between the liquid and the environment through the entrance opening and to permit the printing plate to pass through the entrance opening into the liquid and an exit seal operably configured to seal the exit opening to reduce interaction between the liquid and the environment through the exit opening and to permit the printing plate to pass through the exit opening when being discharged from the liquid. The container is operably configured to contain the liquid such that the surface of the liquid is at or below the entrance seal and the exit seal and such that substantially no head of liquid bears on the entrance and the exit seals.

### BACKGROUND OF THE INVENTION

1. Field of Invention

This invention relates to printing and more particularly to a printing plate processor for preparing a printing plates for a printing operation.

2. Description of Related Art

Many printing operations on printing presses require provision of a printing plate bearing an image to be printed. The printing plate commonly includes a substrate and a sensitized layer coated on the substrate. The substrate may be a thin, flexible sheet of aluminium or polyester. For an offset printing operation, the printing plate may be a lithographic printing plate.

An image is formed on the printing plate by subjecting the sensitized layer to image forming radiation. In many cases the imaged printing plate requires further processing before it is ready to use in a printing operation on the printing press. Such processing may include immersing the imaged printing plate in one or more liquids containing chemicals that further develop or process the image. The processing may also include brushing to assist in the removal of a portion of the sensitized layer and may further include washing the plate to remove processing residues, and applying gum to protect the printing plate. In some cases processing may also include pre-heating and/or post-baking the printing plate.

Printing plate processors are available for at least partially automating some of the processing tasks. However, operating a printing plate processor in a typical printing operation represents a substantial additional expense since the processor should be monitored and replenished with fresh liquid on a continuous basis and also requires regular cleaning. Failure to adequately control processing conditions may result in unusable printing plates being produced potentially delaying a press run on the printing press. Monitoring of the processor is fairly labour intensive since the processing activity of the liquid commonly changes over time and/or with the number of plates being processed.

### SUMMARY OF THE INVENTION

In accordance with one aspect of the invention there is provided an apparatus for cleaning an element used in a printing plate processor, the printing plate processor including a container for containing a liquid used in performing the processing operation on the printing plate. The apparatus includes a cleaner located in the container, the cleaner being moveable to clean the element to be cleaned and an actuator coupled to the cleaner and operably configured to move the cleaner to clean the element.

The printing plate processor may include an entrance operable to receive the printing plate into the liquid and an exit operable to discharge the printing plate from the liquid.

The container may include a guide operable to guide the printing plate from the entrance to the exit and the element to be cleaned may include the guide.

The container may include a wall extending from the entrance to the exit and the element to be cleaned may include at least a portion of the wall.

At least one of the entrance and the exit may include a roller and the element to be cleaned may include the roller.

The printing plate processor may include a brush operably configured to brush the printing plate to remove material that has been operated on by the liquid and the element to be cleaned may include the brush.

The cleaner may include at least one of a brush, a wiper blade, a water jet and an air jet.

The apparatus may include a track operable to guide the cleaner to clean the element and the actuator may be operably configured to move the cleaner along the track.

The track may be operably configured to guide the cleaner to clean more than one element.

The apparatus may include a rotateable drum operably configured to receive the printing plate on a surface of the drum and to convey the printing plate through the liquid.

The element to be cleaned may include the drum.

The cleaner may be coupled to the drum and the drum may act as the actuator.

The printing plate processor may include a brush operable to brush the printing plate to remove material that has been operated on by the liquid and the brush may be operably configured to clean the drum.

The cleaner and the brush may be configured such that the cleaner and the brush are operable to move into contact each other to clean at least one of the brush and the cleaner.

The apparatus may include a clamp operable to clamp an edge of the printing plate to the drum and the cleaner may be coupled to the clamp, the drum being operable to move the clamp and the cleaner.

The cleaner may be operable to dislodge residue from the element to be cleaned and the container may include a drain for draining liquid from the container such that the residue may be flushed out of the container.

The element to be cleaned may include the drain.

The printing plate processor may include at least one sensor operably configured to produce an output, the output being representative of a condition of the liquid and the cleaner may be responsive to the output to clean the element when the output indicates that cleaning is required based on the condition of the liquid.

The container may include an inlet for supplying liquid to the container and the apparatus may include a pump, the pump being operable to cause a flow of liquid in the container between the inlet and the drain, the flow being operable to flush the residue out of the container.

The inlet may be operably configured such that the flow is substantially uniform across the container.

The inlet may include a plurality of inlet openings, the plurality of inlets being operably configured such that the flow is substantially uniform across the container.

The drain may be operably configured such that the flow is substantially uniform across the container.

The drain may include a plurality of outlet openings, the outlet openings being operably configured such that the flow is substantially uniform across the container.

The apparatus may include a filter operably configured to remove the residue from the liquid.

The printing plate processor may be operable to convey the printing plate along a path through the liquid and the inlet and the drain may be located such that a direction of the flow in the container is generally aligned with the path.

The inlet may be a first inlet and the flow may be a first flow and the apparatus may include a second inlet operable to cause a second flow between the second inlet and the drain, the second inlet being located such that a direction of the second flow is generally aligned with the path and in a generally opposite direction to the first flow.

The apparatus may include a plurality of inlets and a plurality of drains, the inlets and the drains being located to cause a plurality of counteracting flows generally aligned with the path.

The apparatus may include an inlet operable to permit a cleaning solvent to be delivered to the container, the cleaning solvent being operable to facilitate cleaning of the element.

The apparatus may include a storage reservoir for receiving liquid drained from the container.

The container may include an inlet operable to supply liquid to the container and the storage reservoir may include an outlet conduit connected to the inlet, the outlet conduit operable to re-introduce the liquid into the container from the storage reservoir after the cleaning of the element has been completed.

The storage reservoir may include an air inlet for receiving pressurized air from a supply of pressurized air having at least a portion of a constituent of air removed therefrom to reduce oxidation of the liquid in the storage reservoir.

The constituent of air may include carbon dioxide.

The storage reservoir may include an inlet for receiving liquid from a supply of liquid to replenish liquid that may be wasted while draining the liquid out of the container.

The supply of liquid may include a supply of concentrated liquid.

The storage reservoir may include a drain outlet for removing at least a portion of the liquid before replenishing the liquid.

The container may include an inlet for adding an additive to the liquid before draining the liquid from the container.

The additive may be a neutralizer and the apparatus may include a pH sensor operable to generate a signal representing a pH level of the liquid and a valve operable to control addition of the neutralizer to the liquid in response to the signal.

In accordance with another aspect of the invention there is provided an apparatus for cleaning an element used in a printing plate processor, the printing plate processor including a container for containing a liquid used in performing the processing operation on the printing plate. The apparatus includes cleaning provisions for cleaning the element, the cleaning provisions being moveable to clean the element to be cleaned and actuator provisions for moving the cleaning provisions to clean the element.

The printing plate processor may include an entrance for receiving the printing plate into the liquid and an exit for discharging the printing plate from the liquid.

The container may include guide provisions for guiding the printing plate from the entrance to the exit and the element to be cleaned may include the guide provisions.

The apparatus may include provisions for removing material from the printing plate that has been operated on by the liquid and the element to be cleaned may include the provisions for removing material.

The apparatus may include provisions for causing the provisions for removing material and the cleaning provisions to contact each other to effect cleaning of at least one of the provisions for removing material and the cleaning provisions.

The apparatus may include provisions for guiding the cleaner to clean the element.

The provisions for guiding may include provisions for guiding the cleaner to clean more than one element.

The apparatus may include provisions for receiving the printing plate on a surface of a rotateable drum and drive provisions associated with the drum for conveying the drum and the printing plate through the liquid and the cleaning provisions may be coupled to the drum.

The apparatus may include clamping provisions for clamping an edge of the printing plate to the drum and the cleaning provisions may be coupled to the clamping provisions.

The cleaning provisions may be operable to dislodge residue from the element to be cleaned and the apparatus may include provisions for flushing residue out of the container.

The element to be cleaned may include the provisions for flushing residue out of the container.

The apparatus may include provisions for circulating the liquid in the container and filter provisions for filtering the residues from the circulating liquid.

The printing plate processor may include provisions for conveying the printing plate along a path through the liquid between the entrance and the exit to the container and the provisions for circulating the liquid may include provisions for causing a flow of liquid in the container, the flow having a direction generally aligned with the path.

The flow may be a first flow and the apparatus may include provisions for causing a second flow of liquid in the container, the second flow having a direction generally aligned with the path and in a generally opposite direction to the first flow.

The apparatus may include provisions for causing a plurality of counteracting flows in said container.

The apparatus may include provisions for draining the liquid from the container and provisions for delivering a cleaning solvent to the container, the cleaning solvent being operable to facilitate cleaning of the element.

The apparatus may include a storage reservoir for receiving liquid drained from the container.

The apparatus may include provisions for re-introducing the liquid into the container from the storage reservoir after the cleaning of the element has been completed.

The storage reservoir may include provisions for receiving liquid from a supply of liquid to replenish liquid that may be wasted while draining the liquid out of the container.

The storage reservoir may include provisions for removing at least a portion of the liquid before replenishing the liquid.

The container may include provisions for adding an additive to the liquid before draining the liquid from the container.

The additive may be a neutralizer and the apparatus may include provisions for generating a signal representing a pH level of the liquid and provisions for controlling addition of the neutralizer to the liquid in response to the signal.

The printing plate processor may include provisions for monitoring a condition of the liquid and provisions for causing the cleaning provisions to clean the element when the condition of the liquid indicates that cleaning is required.

In accordance with another aspect of the invention, in a printing plate processor, the printing plate processor including a container for containing a liquid used in performing the processing operation on the printing plate, a method is provided for cleaning an element used in the plate processor. The method involves causing an actuator to move a cleaner to clean the element to be cleaned.

Cleaning the element may involve cleaning a portion of a wall of the container.

Cleaning the element may involve cleaning a brush, the brush being operable to remove material from the printing plate that has been operated on by the liquid.

The method may involve guiding the cleaner to contact the element to be cleaned.

The method may involve guiding the cleaner to contact more than one element to be cleaned.

The method may involve coupling the cleaner to a drum for movement therewith, the drum operable to receive the printing plate on a surface thereof and to convey the printing plate through the liquid.

The method may involve coupling the cleaner to a clamp, the clamp operable to clamp an edge of the printing plate to the drum.

The cleaner may be operable to dislodge residue from the element to be cleaned and the method may involve flushing residue out of the container.

Flushing residue out of the container may include flushing residue out of the container through a drain in the container and cleaning the element may include cleaning the drain.

The method may involve circulating the liquid in the container and filtering the residues from the circulating liquid.

The method may involve conveying the printing plate along a path through the liquid and circulating the liquid may involve causing a flow of liquid in the container, the flow having a direction generally aligned with the path.

The flow may be a first flow and the method may involve causing a second flow of liquid in the container, the second flow having a direction generally aligned with the path and in a generally opposite direction to the first flow.

The method may involve draining the liquid from the container and delivering a cleaning solvent to the container, the cleaning solvent being operable to facilitate cleaning of the element.

The method may involve receiving liquid drained from the container in a storage reservoir.

The method may involve removing at least a portion of a constituent of air from air in the storage reservoir.

The method may involve re-introducing the liquid into the container from the storage reservoir after the cleaning of the element has been completed.

The method may involve receiving liquid from a supply of liquid in the storage reservoir to replenish liquid that is wasted while draining the liquid out of the container.

The method may involve removing at least a portion of the liquid before replenishing the liquid.

The method may involve adding an additive to the liquid before draining the liquid from the container.

The additive may be a neutralizer and the method may involve generating a signal representing a pH level of the liquid and controlling addition of the neutralizer to the liquid in response to the signal.

The method may involve monitoring a condition of the liquid and causing the cleaner to clean the element when the condition of the liquid indicates that cleaning is required.

In accordance with another aspect of the invention there is provided an apparatus for performing a processing operation on a printing plate. The apparatus includes a container operably configured to contain a liquid for use in performing the processing operation on the printing plate and a cover operably configured to cover a surface of the liquid in the container to reduce interaction between the liquid and an environment about the container, the cover defining an entrance opening operably configured to admit the printing plate into the liquid and an exit opening operably configured to permit the printing plate to be discharged from the liquid. The apparatus also includes an entrance seal operably configured to seal the entrance opening to reduce interaction between the liquid and the environment through the entrance opening and to permit the printing plate to pass through the entrance opening into the liquid and an exit seal operably configured to seal the exit opening to reduce interaction between the liquid and the environment through the exit opening and to permit the printing plate to pass through the exit opening when being discharged from the liquid. The container is operably configured to contain the liquid such that the surface of the liquid is at or below the entrance seal and the exit seal and such that substantially no head of liquid bears on the entrance and the exit seals.

The entrance seal and the exit seal are operable to reduce interaction between the liquid and the environment while the printing plate is passing through the entrance and the exit openings.

At least one of the entrance seal and the exit seal may include a first roller having a first cylindrical surface and a second roller having a second cylindrical surface, the first cylindrical surface and the second cylindrical surface being in contact and defining a nip seal therebetween.

The apparatus may include an end seal operable to seal an end of at least one of the first roller and the second roller. The end seal may include a slip disk and a compliant disk, the compliant disk being located between the end of the roller and the slip disk and being operably configured to bias the slip disk into contact with a sidewall of the container, thereby sealing the end of the roller while permitting rotation of the roller.

At least one of the first roller and the second roller may include a driven roller operably configured to advance the printing plate through the nip seal into or out of the liquid.

The container may be operably configured to contain the liquid such that a space is defined between the surface of the liquid and at least one of the entrance seal and the exit seal and the apparatus may include an inlet for delivering a gas into the space, the gas operable to reduce interaction between the liquid and the environment.

The apparatus may include a guide operable to guide the printing plate through the liquid from the entrance opening to the exit opening.

The guide may include at least one roller located between the entrance opening and the exit opening.

The cover may include a rotateable drum operably configured to receive the printing plate on a surface of the drum and to convey the printing plate through the liquid from the entrance opening to the exit opening.

At least one of the entrance seal and the exit seal may include a roller located in the entrance opening or the exit opening, the roller having a cylindrical surface operably configured to contact the drum to define a nip seal between the cylindrical surface and the surface of the drum.

The apparatus may include a load roller operable to cause the printing plate to be forced into close contact with the surface of the drum thereby reducing interaction between the liquid and a surface of the printing plate in contact with the drum.

The apparatus may include a leading edge clamp operable to clamp a leading edge of the printing plate to the surface of the drum.

The leading edge clamp may include a moveable member configured to fit complementarily into a recess in the surface of the drum thereby reducing carry out of liquid through the exit seal, the moveable member being operable to clamp the leading edge between the moveable member and a surface of the recess.

The apparatus may include a trailing edge clamp operable to apply a retaining force to a trailing edge region of the printing plate to retain the trailing edge region of the printing plate in contact with the surface of the drum.

The apparatus may include a support member coupled to the leading edge clamp, the support member operably configured to bear on a wall of the container thereby augmenting the retaining force.

The trailing edge clamp may be operably configured to move independently of the drum to facilitate movement of the trailing edge clamp with respect to the drum while the printing plate is being subjected to a processing operation thereby preventing masking of a portion of the trailing edge region of the printing plate.

The trailing edge clamp may be operably configured to retain the trailing edge region of the printing plate after the leading edge of the printing plate has passed through the entrance opening into the liquid.

The apparatus may include a cleaner coupled to the trailing edge clamp and moveable therewith, the cleaner being operable to contact an element to be cleaned in the container.

The element may be at least one of the entrance seal, the exit seal, the drum, the leading edge clamp, a wall of the container, a drain operable to drain liquid from the container, or a brush operable to remove material from the printing plate acted on by the liquid.

The apparatus may include a brush operable to remove material from the printing plate acted on by the liquid, the brush being located proximate the exit opening such that a substantial portion of material removed by the brush is directed downwardly in a direction away from the exit seal.

The exit seal may be operably configured such that when the printing plate is discharged from the liquid the printing plate is in a generally vertical orientation thereby reducing carry out of the liquid through the exit seal.

The apparatus may include a heater operable to raise a temperature of the liquid above a temperature of the environment about the container thereby increasing activity of the processing operation.

In accordance with another aspect of the invention there is provided an apparatus for performing a processing operation on a printing plate. The apparatus includes a container operably configured to contain a liquid for use in performing the processing operation on the printing plate and provisions for covering a surface of the liquid in the container to reduce interaction between the liquid and an environment about the container, the provisions for covering defining an entrance opening for admitting the printing plate into the liquid and an exit opening for permitting the printing plate to be discharged from the liquid. The apparatus also includes entrance seal provisions for sealing the entrance opening to reduce interaction between the liquid and the environment through the entrance opening and to permit the printing plate to pass through the entrance opening into the liquid and exit seal provisions for sealing the exit opening to reduce interaction between the liquid and the environment through the exit opening and to permit the printing plate to pass through the exit opening when being discharged from the liquid. The container is operably configured to contain the liquid such that the surface of the liquid is at or below the entrance seal provisions and the exit seal provisions and such that substantially no head of liquid bears on the entrance seal provisions and the exit seal provisions.

The entrance seal provisions and the exit seal provisions may include provisions for reducing interaction between the liquid and the environment while the printing plate is passing through the entrance and the exit openings.

At least one of the entrance seal provisions and the exit seal provisions may include provisions for defining a nip seal for sealing the entrance or the exit opening, the nip seal operable to permit the printing plate to pass therethrough while reducing interaction between the liquid and the environment.

The provisions for defining the nip seal may be operable to advance the printing plate through the nip seal into or out of the liquid.

The container may be operably configured to contain the liquid such that a space is defined between the surface of the liquid and at least one of the entrance seal provisions and the exit seal provisions and the apparatus may include provisions for delivering a gas into the space, the gas operable to reduce interaction between the liquid and the environment.

The apparatus may include guide provisions for guiding the printing plate through the liquid from the entrance opening to the exit opening.

The provisions for covering may include a rotateable drum having provisions for receiving the printing plate on a surface of the drum and provisions for conveying the printing plate through the liquid from the entrance opening to the exit opening.

At least one of the entrance seal provisions and the exit seal provisions may include provisions for defining a nip seal between the entrance opening or the exit opening and the surface of the drum.

The apparatus may include provisions for causing the printing plate to be forced into close contact with the surface of the drum thereby reducing interaction between the liquid and a surface of the printing plate in contact with the drum.

The apparatus may include leading edge clamping provisions for clamping a leading edge of the printing plate to the surface of the drum.

The apparatus may include trailing edge clamping provisions for applying a retaining force to a trailing edge region of the printing plate to retain the trailing edge region of the printing plate in contact with the surface of the drum.

The trailing edge clamping provisions may include provisions for facilitating movement of the trailing edge clamp with respect to the drum while the printing plate is being subjected to a processing operation thereby preventing masking of a portion of the trailing edge region of the printing plate.

The trailing edge clamping provisions may include provisions for retaining the trailing edge region of the printing plate after the leading edge of the printing plate has passed through the entrance opening into the liquid.

The apparatus may include cleaner provisions for cleaning an element, the cleaner provisions being coupled to the trailing edge clamping provisions and moveable therewith, the cleaner provisions being operable to contact the element to be cleaned in the container.

The apparatus may include provisions for removing material from the printing plate acted on by the liquid, the provisions for removing being located proximate the exit opening such that a substantial portion of material removed by the provisions for removing is directed downwardly in a direction away from the exit seal provisions.

The exit seal provisions may include provisions for discharging the printing plate from the liquid in a generally vertical orientation thereby reducing carry out of the liquid through the exit seal provisions.

The apparatus may include provisions for raising a temperature of the liquid above a temperature of the environment about the container thereby increasing activity of the processing operation.

In accordance with another aspect of the invention there is provided a method for performing a processing operation on a printing plate in a container operably configured to contain a liquid for use in performing the processing operation on the printing plate. The method involves covering a surface of the liquid in the container to reduce interaction between the liquid and an environment about the container and sealing an entrance opening to the container such that substantially no head of liquid bears on the sealed entrance opening, the sealing being operable to reduce interaction between the liquid and the environment through the entrance opening and to permit the printing plate to pass through the entrance opening into the liquid. The method also involves sealing an exit opening to the container such that substantially no head of liquid bears on the sealed exit opening, the sealing operable to reduce interaction between the liquid and the environment through the exit opening and to permit the printing plate to pass through the exit opening when being discharged from the liquid.

Sealing the entrance and sealing the exit may involve sealing the exit and the entrance such that interaction between the liquid and the environment is reduced while the printing plate is passing through the entrance and the exit openings.

The method may involve introducing a gas into a space between a surface of the liquid and the entrance opening and the exit opening, the gas operable to reduce interaction between the liquid and the environment.

The method may involve guiding the printing plate through the liquid from the entrance opening to the exit opening.

Covering the container may involve covering the container using a rotateable drum, the rotateable drum being operable to receive the printing plate on a surface of the drum and to convey the printing plate through the liquid from the entrance opening to the exit opening.

The method may involve causing the printing plate to be forced into close contact with the surface of the drum thereby reducing interaction between the liquid and a surface of the printing plate in contact with the drum.

The method may involve clamping a leading edge of the printing plate to the surface of the drum.

The method may involve applying a retaining force to a trailing edge region of the printing plate to retain the trailing edge region of the printing plate in contact with the surface of the drum.

Applying a retaining force to a trailing edge region of the printing plate may involve retaining the trailing edge region of the printing plate after the leading edge of the printing plate has passed through the entrance opening into the liquid.

Discharging the printing plate may involve discharging the printing plate from the liquid in a generally vertical orientation thereby reducing carry out of the liquid through the exit seal.

The method may involve raising a temperature of the liquid above a temperature of the environment about the container thereby increasing activity of the processing operation.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a perspective view of a printing plate processor in accordance with a first embodiment of the invention;

FIG. 2 is a cross sectional view of the printing plate processor shown in FIG. 1 taken along the line 2-2;

FIG. 3 is a perspective view of a roller end seal for implementing the printing plate processor of FIG. 2;

FIG. 4 is a plan view of a first embodiment of a trailing edge clamp for implementing the printing plate processor of FIG. 2;

FIG. 5 is a cross sectional view of the trailing edge clamp shown in FIG. 4 taken along lines 5-5;

FIG. 6 is a is an exploded perspective view of a leading edge clamp for implementing the printing plate processor of FIG. 2;

FIG. 7 is a cross sectional view of a circulation system and a liquid storage system for use with the printing plate processor shown in FIG. 2;

FIGS. 8-13 are a series of cross sectional views illustrating the operation of the printing plate processor of FIG. 2;

FIG. 14 is a plan view of another embodiment of a trailing edge clamp for implementing the printing plate processor of FIG. 2;

FIG. 15 is a cross sectional view of the trailing edge clamp shown in FIG. 14 taken along lines 15-15; and

FIG. 16 is a cross sectional view of a printing plate processor in accordance with another embodiment of the invention.

### DETAILED DESCRIPTION

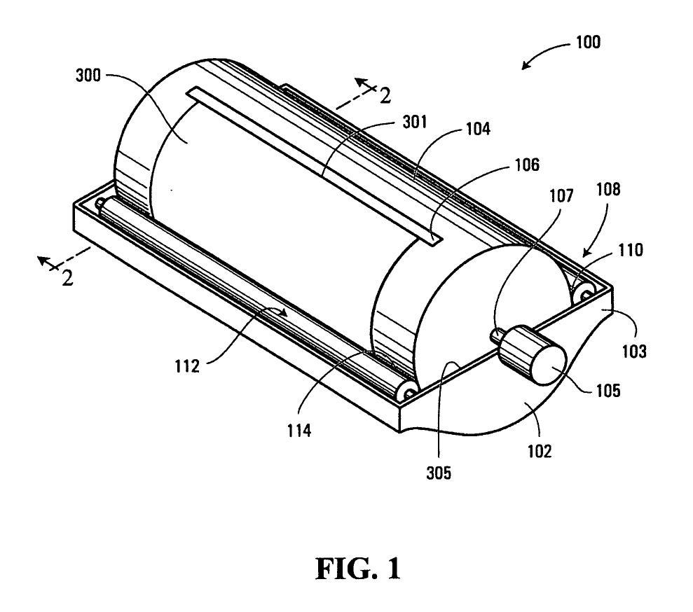

Referring to FIG. 1, a printing plate processor according to a first embodiment of the invention is shown generally at 100. The printing plate processor 100 includes a container 102 for containing a liquid for use in performing a processing operation on a printing plate 300. The printing plate processor 100 also includes a drum 104 for conveying the printing plate 300 through the liquid. The drum 104 includes a leading edge clamp 106 for clamping a leading edge 301 of the printing plate 300 to the drum and is coupled to a drum drive motor 105 via a drum drive shaft 107. The drum drive motor 105 includes facilities for controlling the drum such that it may be positioned as required by the processing operation. The drum drive motor 105 may include an encoder (not shown) for indicating a rotational position of the drum 104 and for controlling the rotation of the drum. The printing plate processor 100 further includes an entrance opening 108 and an exit opening 112. The entrance opening 108 includes an entrance seal 110 and the exit opening 112 includes an exit seal 114. The printing plate processor 100 further includes a drum seal 305 for sealing between the drum 104 and a sidewall 103 of the container 102 (a similar drum seal is located on the distal end of the drum).

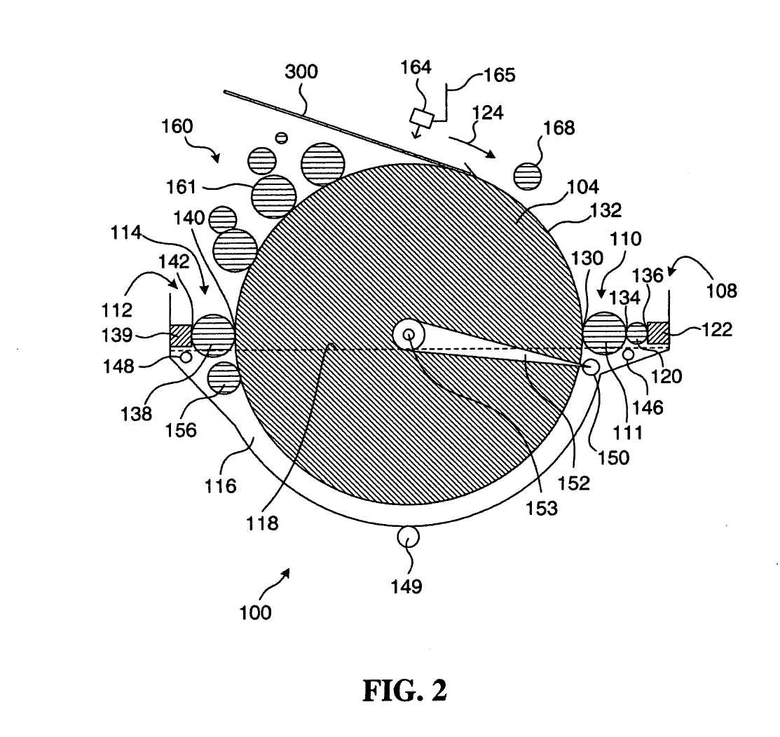

The printing plate processor 100 is shown in cross-sectional detail in FIG. 2. The container 102 may be filled with a liquid 116, such that a surface of the liquid is just below or washes the bottom of the seals 110 and 114. The entrance seal 110 includes a first roller 111, a second roller 120, and a compliant member 122. The compliant member 122 is sealingly attached the container 102. The first roller 111 is in contact with a surface 132 of the drum 104. The second roller 120 is in contact with the first roller 111 and the second roller is also in contact with the compliant member 122. The rollers 111 and 120 are configured such that they are able to rotate freely (i.e. in this embodiment the rollers are not driven).

The exit seal 114 includes a third roller 138 in contact with the surface 132 of the drum 104. The exit seal 114 also includes a compliant member 139, which is sealingly connected to the container 102. The third roller 138 is in contact with the surface 132 of the drum 104 and is also in contact with the compliant member 139.

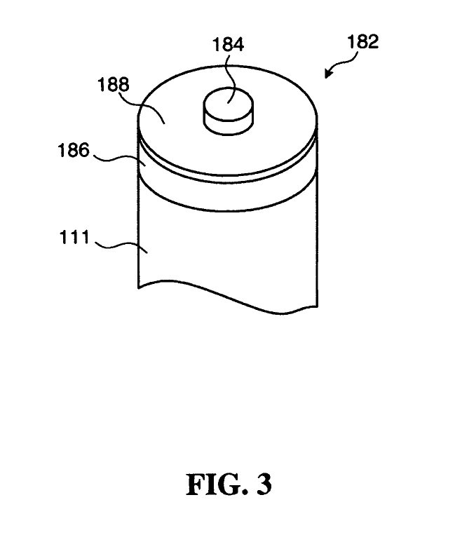

Referring to FIG. 3, a partial view of an end seal of the first roller 111 is shown at 182. The first roller 111 includes a mounting pin 184 for supporting the first roller in the container 102. The end seal 182 includes a compliant disk 186 and a slip disk 188. The compliant disk 186 may be rubber or foam. The slip disk 188 may be fabricated from a material such as polytetrafluoroethylene (PTFE) sold by DuPont under the trademark Teflon®. The rollers 111, 120 and 138 include end seals similar to the end seal 182 on both ends of the rollers, although the compressible disk 186 may be omitted on one of the ends if the compressible disk on the other end is sufficiently compressible to allow insertion of the rollers. Advantageously the slip disk 188 and compliant disk 186 may be cheaply fabricated and easily replaced should they become worn after extended use.

Returning to FIG. 2, the printing plate processor 100 also includes a first inlet 146 located near the entrance opening 108 and a second inlet 148 located near the exit opening 112, The printing plate processor 100 further includes and a drain 149 located at a low point of the container 102. The first and second inlets 146 and 148 may extend across the width of the container 102 and may include a plurality of inlet openings (not shown) for delivering the liquid 116 to the container. Similarly the drain 149 may extend across the width of the container 102 and may include a plurality of outlet openings for removing the liquid 116 from the container. Conveniently the inlets 146 and 148 and the drain 149 may each include a tube, extending at least partway along the width of the container 102 (i.e. into the page in FIG. 2). The tubes may include a plurality of holes located and/or dimensioned to ensure a substantially uniform flow of the liquid 116 through the container 102, thus ensuring that the processing operation is uniform across the printing plate 300. Alternatively the tubes may include an elongate opening extending at least partway along the tube and shaped to ensure a substantially uniform flow of the liquid 116 through the container 102.

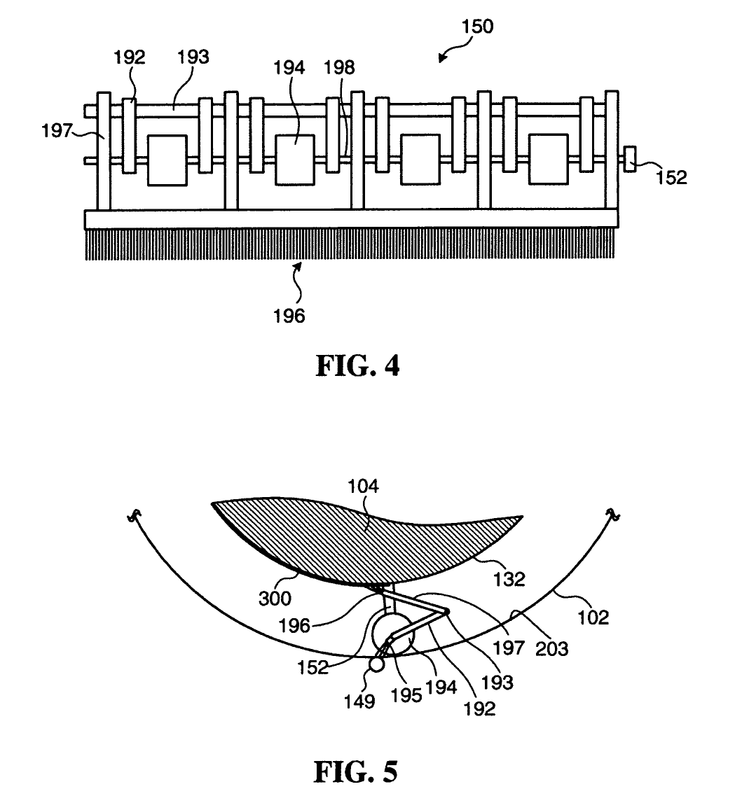

The printing plate processor 100 also includes a trailing edge clamp 150 for clamping a trailing edge region of the printing plate 300. A first embodiment of the trailing edge clamp is shown in greater detail in FIG. 4 and FIG. 5. The trailing edge clamp 150 includes a first shaft 198 and a plurality of rollers 194 located on the first shaft. The first shaft 198 is coupled to the actuator arm 152. The trailing edge clamp 150 also includes a cleaner, which in the embodiment shown is a cleaner brush 196, a first linkage 197, a second linkage 192, and a second shaft 193. Alternatively the cleaner may be a plurality of jets for directing air, solvent or liquid towards the surface to be cleaned. The cleaner may also be a wiper blade. The first linkage 197 includes a first end coupled to the cleaner brush 196 and a second end coupled to the second shaft 193. The second linkage 192 includes a first end coupled to the first shaft 198 and a second end coupled to the second shaft 193. The linkages 197 and 192 are configured such that the cleaner brush 196 bears on the printing plate 300 while the rollers 194 bear on a wall 203 of the container 102. Advantageously, since the trailing edge clamp 150 bears on the wall 203 of the container 102, the first shaft 198 is supported by the wall and does not have to be as rigid as would be required without the support of the wall of the container. The trailing edge clamp 150 may also include a second cleaner brush 195 for cleaning the wall 203 of the container 102.

Referring back to FIG. 2, the trailing edge clamp 150 is coupled to an actuator arm 152. The arm 152 includes a pivot 153, which is concentrically located with respect to the drum drive shaft 107. The arm 152 further includes an arm drive motor (not shown) which is coupled to the arm proximate the pivot 153. The arm drive motor facilitates moving the trailing edge clamp through the container 102 between the entrance opening and the exit opening. Independently driving the trailing edge clamp facilitates easily accommodating different sizes of printing plates. Alternatively the arm 152 may be directly or indirectly coupled to the drum drive motor 105 such that the arm is rotateable in conjunction with the drum 104.

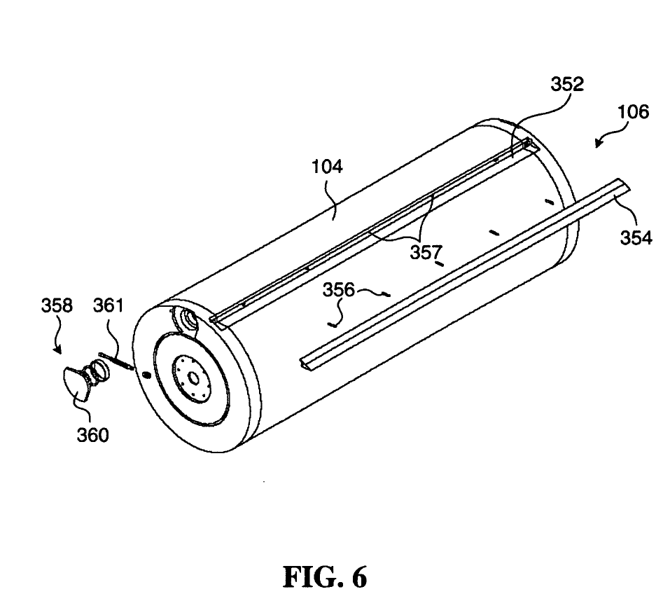

Referring now to FIG. 6 the drum 104 and the leading edge clamp 106 are shown in exploded detail. The leading edge clamp 106 includes a cam actuator 358, a clamp bar 354 and a plurality of guide pins 356 which are coupled to the clamp bar. The drum 104 includes a recess 352 that is complementarily shaped to accommodate the clamp bar 354. The drum 104 also includes a plurality of guide holes 357 for receiving the guide pins 356. The cam actuator 358 includes a cam 360 and a linkage 361. A second cam actuator and linkage (not shown) is located on the distal end of the drum 104. The linkage 361 is coupled to clamp bar 354 and couples an actuating force between the cam 360 and the clamp bar. In use the cam actuator 358 contacts a protruding element on a sidewall of the container that causes the cam 360 to be rotated. The rotation causes the linkage 361 to actuate the clamp bar 354 to open or close depending on the positioning of the drum with respect to the protruding element. The printing plate 300 is clamped between the clamp bar 354 and a rear face of the recess 352.

Returning to FIG. 2, the printing plate processor 100 also includes a processor brush 156 located near the exit opening 112. The processor brush 156 may be a cylindrical brush and may include a drive (not shown) for rotating the brush to remove residue from the printing plate 300. The drive may include a belt or chain coupling the processor brush 156 to the drum drive motor 105. The printing plate processor 100 further includes a load guide roller 168 which is actuable from the position shown in FIG. 2 to a position in contact with the surface 132 of the drum 104. The printing plate processor 100 further includes a wash section 160 for washing residue from the printing plate 300. The wash section 160 includes a wash brush 161. The printing plate processor 100 further includes a proximity sensor 164 for sensing the presence of a printing plate and for measuring the length of a printing plate. The proximity sensor 164 includes an output 165 for producing a signal when the proximity sensor senses the presence of the printing plate 300.

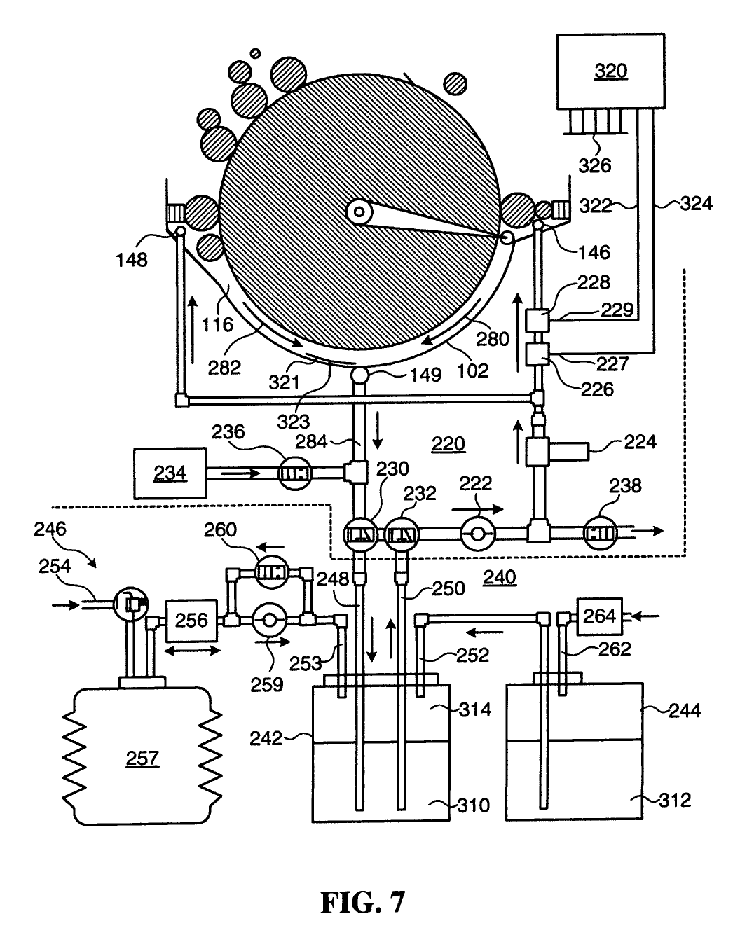

Referring to FIG. 7, the printing plate processor 100 further includes a circulation system shown generally at 220. The circulation system 220 includes a pump 222 connected between the drain 149 and the first and second inlets 146 and 148. The circulation system 220 also includes a filter 224, a pH sensor 226 and a conductivity sensor 228, all connected in line with the pump 222. The pH sensor 226 has an output 227 for producing a signal representing the pH of the liquid 116 circulating therethrough. The conductivity sensor 228 has an output 229 for producing a signal representing the electrical conductivity of the liquid 116 circulating therethrough. The circulation system 220 also includes a first valve 230 and a second valve 232 for directing the flow of the liquid 116 in the circulation system. The circulation system 220 also includes a cleaning solvent supply 234 in communication with the circulation system through a valve 236. The circulation system 220 also includes a valve 238 that is operable to direct waste liquid to a drain such as a common sewer drain (the sewer drain is not shown). The printing plate processor 100 may also include a heater 321 for increasing a temperature of the liquid 116 thereby increasing the activity of the liquid. The heater may include inputs 323 for receiving a current that controls the heater and for producing an output signal representing the temperature of the liquid 116 in the container 102.

The printing plate processor 100 also includes a liquid storage system 240 for storing and supplying liquid to the printing plate processor 100 for use in the processing operation. The liquid storage system 240 includes a storage reservoir 242, a replenishment container 244, and a CO₂ reduced air supply system 246. The storage reservoir 242 includes an inlet conduit 248 for receiving the liquid 116 from the container 102, which is diverted by the first valve 230. The storage reservoir 242 also includes an outlet conduit 250 in communication with the circulation system 220 through the second valve 232. The storage reservoir 242 also includes an inlet 252 in communication with the replenishment container 244 for receiving replenishment liquid from the replenishment container. The replenishment container 244 includes an air inlet 262 and a CO₂ scrubber 264 for selectively supplying CO₂ reduced air to the replenishment container to cause the replenishment liquid to be supplied to the storage reservoir 242.

The CO₂ reduced air supply system 246 includes an inlet 254 for receiving pressurized air and a CO₂ scrubber 256 for removing at least a portion of the carbon dioxide from the air. The CO₂ reduced air supply system 246 further includes a pump 259 and a valve 260, which are connected in parallel between the CO₂ scrubber 256 and the air inlet 253. The CO₂ reduced air supply system 246 further includes an expandable reservoir 257 connected between the air inlet 254 and the CO₂ scrubber 256.

The printing plate processor 100 further includes a controller 320 for controlling operations of the printing plate processor. The controller 320 includes an input 324 for receiving a signal representing the pH of the liquid 116 from the pH sensor 226 and an input 322 for receiving a signal representing the conductivity of the liquid 116 from the conductivity sensor 228. The controller 320 further includes a plurality of outputs for producing control signals to control operation of the valves 230, 232, 238, 236 and 260, the pumps 222 and 259 as well as the drum drive motor 105, the trailing edge clamp actuator arm 152 and the heater 321.

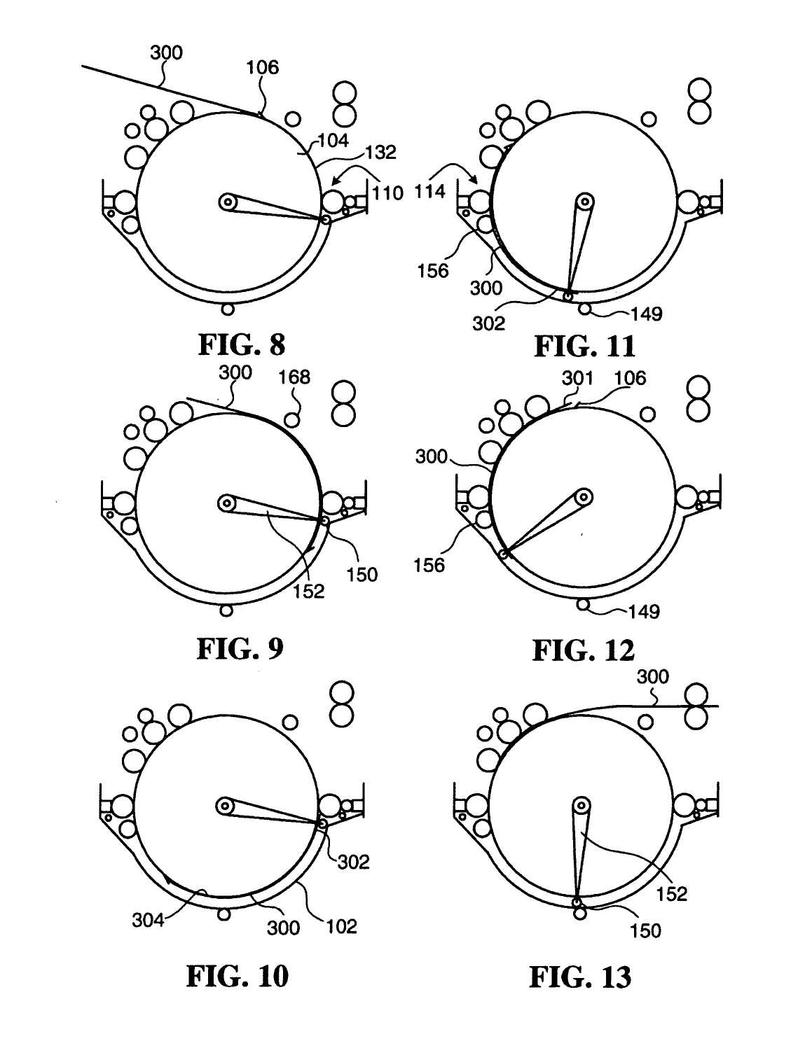

The operation of the printing plate processor 100 is described in relation to FIGS. 8-13 and with further reference to FIGS. 1-7. Referring to FIG. 8, the drum 104 is initially positioned so that the leading edge clamp 106 is able to receive the printing plate 300. Referring to FIG. 6 the leading edge clamp 106 is actuated to open (and close) by the cam actuator 358, which is in turn actuated by rotating the drum to engage an element (not shown) protruding from the sidewall 103 into the container 102 (between the drum and the sidewall). Advantageously, actuating the cam 360 through rotation of the drum 104 facilitates opening and closing the leading edge clamp 106 at the required locations without the need to provide a separate drive to actuate the leading edge clamp. The leading edge clamp 106 is thus automatically opened when the drum is in position to receive the printing plate 300. The drum 104 is then rotated by the drum drive motor 105, thus conveying the printing plate 300 towards the entrance seal 110. The leading edge clamp 106 is automatically closed through rotation of the drum 104 and the action of the cam actuator 358.

Referring to FIG. 9, the drum 104 is rotated to convey the printing plate 300 through the entrance seal 110. The load guide roller 168 is also actuated to firmly retain the printing plate 300 against the surface 132 of the drum 104.

The operation of the entrance seal 110 is described in relation to FIG. 2. When the drum 104 is rotated in the direction shown by arrow 124 (clockwise), the first roller 111 bearing against the surface 132 of the drum 104 rotates in an anticlockwise direction. A line of contact between the first roller 111 and drum 104 forms a nip seal 130, which maintains a seal while the printing plate 300 is passing through the seal 114 (a “nip” is a place of intersection where one roller contacts another roller or other surface). The second roller 120 rotates in a clockwise direction and a nip seal 134 is formed at a line of contact between the first roller 111 and the second roller. The second roller 120 is also in contact with the compliant member 122 and forms a nip seal 136 at a line of contact between the second roller and the complaint member.

The second roller 120, located between the first roller 111 and the compliant member 122, functions to prevent the liquid 116 from being carried out of the container 102. In operation the surface 118 of the liquid 116 in the container 102 may wash against the bottom of the rollers 111 and 120. If the second roller 120 were omitted, and the first roller 111 formed a nip seal directly with the compliant member 122, the clockwise rotation of the first roller 111 would cause some of the liquid 116 to pool at the top of the nip seal 136, thus exposing a portion of the liquid to air. Many liquids used in processing plates will be affected by or oxidised through exposure to air, and in particular exposure to CO₂, although particular liquids may be more sensitive to other constituents in an environment surrounding the processor. Interaction between the liquid and the environment may cause a premature decline in the processing activity of a liquid used in the printing operation. The second roller 120 allows the nip seal 136 to be formed by a roller having a clockwise rotation direction, which tends to avoid carry out of the liquid 116 from the container 102.

Advantageously, the surface 118 of the liquid 116 in the container 102 may wash against the entrance seal 110 without causing any significant interaction between the liquid and air surrounding the container since the liquid is retained in the container by gravity and will thus tend to run back into the container. The entrance seal 110 is also not required to seal against any significant head of liquid pressure due to the location of the seal at or above a surface level of the liquid 116. Furthermore, when the surface 118 of the liquid 116 is at a level such that it washes the bottom of the entrance seal 110 any airspace between the seal and the surface of the liquid is minimized thus further reducing interaction between the liquid 116 and air surrounding the container 102.

The operation of the exit seal 114 is similar to the operation of the entrance seal 110 except that the third roller 138 has an anticlockwise direction of rotation and thus may bear directly on the compliant member 139 without the need for an additional roller between the third roller 138 and the compliant member 139 to prevent carry out of the liquid 116 from the container 102. The third roller 138 forms a nip seal 140 with the drum 104 and a nip seal 142 with the compliant member 139.

The sealing of the ends of the rollers 111, 120 and 138 is described in relation to FIG. 3 and FIG. 1. The container 102 is dimensioned such that when the rollers 111, 120 and 138 are in place, the compliant disk 186 is compressed to an extent such that the slip disk 188 bears against the sidewall 103 of the container 102 with sufficient force to create a seal therebetween. Advantageously, the use of a low friction material such as PTFE for the slip disk 188 allows the rollers 111, 120 and 138 to rotate freely without causing significant drag.

The combination of the drum seals 305, the various nip seals and the end seals, provides a substantially air-tight container 102, thus reducing interaction between the liquid 116 and air surrounding the container. Such interaction may include both evaporation of the liquid 116 and oxidation of the liquid by coming into contact with air surrounding the container 102. Advantageously, when the surface 118 of the liquid 116 washes against the rollers, any airspace between the liquid surface and the seals is minimized thus preventing oxidation and evaporation of the liquid. Any minimal airspace that exists between the surface 118 of the liquid 116 and the seals will be quickly saturated by evaporation and cease to be a factor in further evaporation. Similarly, only a small amount of CO₂ will initially exist in the airspace and will become quickly depleted through oxidation of the liquid. Alternatively, the airspace may be purged using CO₂ reduced air or another inert gas, thus presenting a layer between the surface of the liquid 116 and air surrounding the container 102 that acts as a barrier to interaction between the liquid and the air.

Returning to FIG. 9, the drum 104 is further rotated to convey the printing plate 300 under the rollers 194 on the trailing edge clamp 150. In this embodiment the trailing edge clamp actuator arm 152 is driven independently of the drum and the trailing edge clamp 150 is initially positioned near the entrance seal 110. The trailing edge clamp 150 remains in this position while the leading edge portion of the printing plate 300 is drawn through the entrance seal and under the rollers 194 of the trailing edge clamp 150. Referring to FIG. 10, the drum 104 is further rotated to convey the printing plate 300 through the container 102. The actuator arm 152 remains stationary until a trailing edge region 302 of the printing plate 300 is free of the entrance seal 110. Advantageously, by driving the arm 152 from an independent drive the trailing edge clamp 150 is not confined to clamping the printing plate 300 at a single location which may cause the location to be masked from the processing activity of the liquid 116. The arm 152 is able to move as the printing plate is conveyed through the liquid 116 thus clamping the printing plate over a trailing edge region 302, rather than at a single location.

Referring now to FIG. 11, the drum 104 is further rotated to convey the printing plate 300 through the container 102 and out of the container through the exit seal 114. The arm 152 moves the trailing edge clamp 150 along with the printing plate 300 such that the trailing edge region 302 remains firmly clamped to the drum. Advantageously, the use of the load guide roller 168 and the trailing edge clamp 150 ensures that the printing plate 300 remains in close contact with the surface 132 of the drum 104, thus reducing interaction between the liquid 116 and a back surface 304 of the printing plate in contact with the drum. Reducing interaction between the liquid 116 and the back surface 304 of the printing plate 300 reduces depletion of processing activity of the liquid 116 due to contact with the back surface 304 of the printing plate, which does not require any processing. As a result, the printing plate processor 100 may be able to process a greater number of printing plates before requiring replenishment or replacement of the liquid 116 due to a loss of processing activity.

When the printing plate 300 is being discharged through the exit seal 114, the processor brush 156 brushes residue from the printing plate 300. The residue may be portions of a surface of the printing plate 300 that have been acted on by the liquid 116 during the processing operation. Advantageously, residues that are removed from the printing plate 300 will tend to settle in the liquid 116 under the action of gravity and will fall towards the drain 149. The processor brush 156 may also be used to clean the exit seal by making the processor brush moveable and actuating the processor brush to move to contact elements of the exit seal 114.

The drum 104 further rotates to convey the printing plate 300 through the wash section 160, which rinses remaining residue and the liquid 116 from the printing plate by spraying the printing plate with a rinse solution and brushing the printing plate using the wash brush 161. The rinse solution may be water. The wash brush 161 may also be used to brush the drum 104 to clean residue from the drum.

Referring to FIG. 12, the leading edge clamp 106 is automatically actuated to open by the cam actuator 358 allowing the leading edge 301 of the printing plate 300 to be released. Referring to FIG. 13, once the printing plate 300 has been completely discharged from the exit seal 114, the arm 152 returns the trailing edge clamp 150 back towards the entrance seal 110 where it will be ready to receive the next printing plate to be processed.

The operation of the circulation system 220 and the liquid storage system 240 is described with reference to FIG. 7. During normal processing operations the first valve 230 and the second valve 232 are actuated or configured such that the pump 222 is able to circulate the liquid 116 from the drain 149 to the container 102 through the first inlet 146 and the second inlet 148, thus causing counteracting flows of liquid in the container in the direction shown by arrows 280 and 282. Advantageously the counteracting flows in the container 102 direct residues downwardly towards the drain 149 and the residue is then extracted from the container through the conduit 284. The liquid 116 that is extracted through the conduit 284 is circulated through the filter 224, which removes at least particulate residues from the liquid. The liquid 116 that is reintroduced into the container 102 through the first and second inlets 146 and 148 thus contains fewer residues than would be the case in an unfiltered circulation system. Furthermore the flows of liquid 116 in the directions indicated by arrows 280 and 282 augment the processing action of the liquid by creating a turbulent flow over the surface of the printing plate 300 as the printing plate is conveyed through the container 102. Alternatively a plurality of inlets and drains may be used to create a plurality of counteracting flows through the container 102, further increasing the turbulence, and hence the processing action due to the liquid operating on the printing plate 300.

The pH sensor 226 monitors the pH of the liquid 116 flowing through the circulation system and generates a signal at the output 227 representing the pH of the liquid. Similarly, the conductivity sensor 228 monitors the electrical conductivity of liquid 116 passing through the circulation system and generates a signal at the output 229 representing the conductivity of the liquid. Conductivity and pH are useful indicators of the state of the liquid 116 in the circulation system 220 and the container 102 and may be monitored to ascertain when a cleaning cycle or a replenishment of the liquid may be required. Alternatively, the printing plate processor 100 may include other sensors for monitoring the condition of the liquid 116 and for determining when a cleaning of the processor may be required. The sensors may also be located in the container and may be located to facilitate cleaning be the cleaner brush 195 or 196.

Advantageously, in contrast to unsealed processors the temperature of the liquid 116 may be increased above the temperature of air surrounding the container 102, since the seals will prevent excessive evaporation of the liquid. Oxidation due to CO₂ also increases with increasing temperature and thus the processor 100 may be operated at higher liquid temperature without significantly increasing the oxidation of the liquid 116. Consequently, in contrast to unsealed processors the printing plate processor 100 may not require the provision of a chiller for maintaining the temperature of the liquid.

When the conductivity and pH indicate that cleaning may be required, the first valve 230 is actuated to drain the liquid 116 from the container 102 and the circulation system 220 through the conduit 248 and into the storage reservoir 242. The storage reservoir 242 may be empty or may be already partially filled with a liquid 310, to which the liquid 116 from the container 102 is added. Unless the storage reservoir is completely filled with the liquid 310, an airspace 314 will exist above the liquid 310, potentially allowing oxidation of the liquid. The CO₂ reduced air supply system 246 operates to ensure that the airspace 314 has a substantial portion of CO₂ removed from the air in the airspace. The valve 260 is opened to allow the liquid 116 from the container 102 to displace the air in the airspace 314. The displaced air flows through the CO₂ scrubber 256 and into the expandable reservoir 257. The expandable reservoir 257 is capable of expanding to accommodate the CO₂ reduced air. When the liquid storage system is first commissioned the air in the airspace 314 may contain a usual portion of CO₂. This may be removed by ensuring that the storage reservoir 242 is completely filled so that substantially no airspace 314 remains. Alternatively, the storage reservoir may be provided with a bleed valve (not shown) allowing CO₂ reduced air to be pumped into the storage reservoir 242 to purge non CO₂ reduced air from the airspace 314 prior to filling the storage reservoir with the liquid 310.

In further use of the storage reservoir 242, whenever liquid is delivered to the reservoir, air from the airspace 314 is allowed to escape through valve 260 and whenever liquid is delivered from the storage reservoir, CO₂ reduced air is pumped into the reservoir by the pump 259.

If necessary, the liquid 310 in the storage reservoir 242 may be topped up or replenished from the replenishment container 244. Advantageously, the replenishment container 244 may contain a concentrated replenishment liquid which may be added to the liquid 310 in the storage reservoir 242 to compensate for any loss in processing activity of the liquid 116. The concentrated replenishment liquid is forced from the replenishment container 244 into the storage reservoir 242 by introducing CO₂ reduced air through the air inlet 262.

After the liquid 116 has been drained from the container 102, the first valve 230 is again reconfigured to permit circulation through the circulation system 220 and the valve 236 is configured to allow cleaning solvent to be introduced into the container 102 from the cleaning solvent supply 234. Once the container 102 has been filled with cleaning solvent, the pump 222 is activated to circulate the cleaning solvent through the container. The cleaning solvent may be water and may also contain additives that are capable of at least partially dissolving printing residues.

During the cleaning, at least a portion of the residues may be captured in the filter 224. The filter 224 may include a filter cartridge that is removed and cleaned or removed and replaced with a new cartridge at some time interval or when the filter becomes clogged. Alternatively the circulation system may be configured to facilitate backwashing the filter such that accumulated residues are flushed out through the valve 238. While the cleaning is in progress the trailing edge clamp 150 is activated to move between the entrance seal 110 and the exit seal 114 such that the cleaner brush 195 brushes the wall 203 of the container 102. The cleaner brush 195 may also be activated to brush the drain 149 and may further be activated to contact the processor brush 156, elements of the entrance seal 110 and/or the exit seal 114. Similarly the cleaner brush 196 may be actuated to clean the drum 104 and the leading edge clamp 106. Furthermore one of the cleaner brushes 195 and 196 may be actuated to contact the processor brush 156 and the processor brush and the cleaning brush may mutually clean each other.

The drum 104 may also be rotated during the cleaning and the processor brush 156 may be activated to brush the drum 104. The brushing of the wall 203, the drain 149, the drum 104 and the processor brush 156 aids in the cleaning by dislodging residue build-up from these elements. The dislodged residue is then flushed out of the container by the circulation system 220 and captured by the filter 224. Alternatively, the printing plate processor 100 may include an element, such as a guide, that is located between the printing plate and the wall 203 of the container 102 and the cleaner brush 196 may be configured to brush the element. Advantageously, the use of the cleaner brush 196 may extend the time for which the liquid 116 retains sufficient activity for processing operations and further aids removal of liquid residues during a cleaning cycle. In another alternative embodiment, liquid or solvent may be supplied to the processor through the drain, thus causing the drum 104 to be sprayed to effect cleaning thereof.

When the cleaning cycle is completed, the valve 238 is actuated to drain the container 102 to a sewer drain or other holding tank. The second valve 232 is then configured to allow the liquid 310 from the storage reservoir 242 to be reintroduced into the container 102. The pump 259 may be operated to pressurise the airspace 314, thus forcing the liquid 310 from the storage reservoir into the conduit 250 to prime the pump 222. The pump 222 may then be activated to fill the container 102.

Advantageously, the removal of the liquid 116 from the container 102 and the storage of the liquid in the storage reservoir 242 facilitates cleaning of the printing plate processor 100 without having to discharge the liquid 116 to a sewer drain and then refill the container with fresh liquid. Regular cleaning will also prevent build-up of residues in the container 102. The cleaning may be performed automatically under the control of the controller 320 allowing cleaning to be scheduled during a low usage period.

Furthermore, during processing operations the cleaner brush 196 brushes the wall 203 of the container 102 and the cleaner brush may also be actuated to brush the drain 149 and the processor brush 156 between processing operations or during low usage periods. Some cleaning may thus be effected between cleaning cycles.

At some stage, after a number of cleaning cycles, the liquid 116 may become unusable and may be diverted to a sewer drain by the valve 238, rather than to the storage reservoir 242. Depending on the liquid in use, the liquid may require treatment prior to being diverted to a sewer drain. Such treatment may include delivering an additive such as a pH neutralizer to the liquid in order to neutralize the pH level of the liquid. Alternatively, contaminants such as printing plate emulsion residues or aluminium particles from the printing plate 300 may accumulate in the liquid and the additive may include a chemical that either promotes precipitation of the contaminants, or in some cases prevents precipitation of the contaminants. Advantageously the printing plate processor may include provisions for delivering an additive such as a neutraliser to the liquid 116 while it is being circulated through the container 102. Conveniently the pH sensor 226 allows neutralizer to be added while monitoring the pH of the liquid 116.

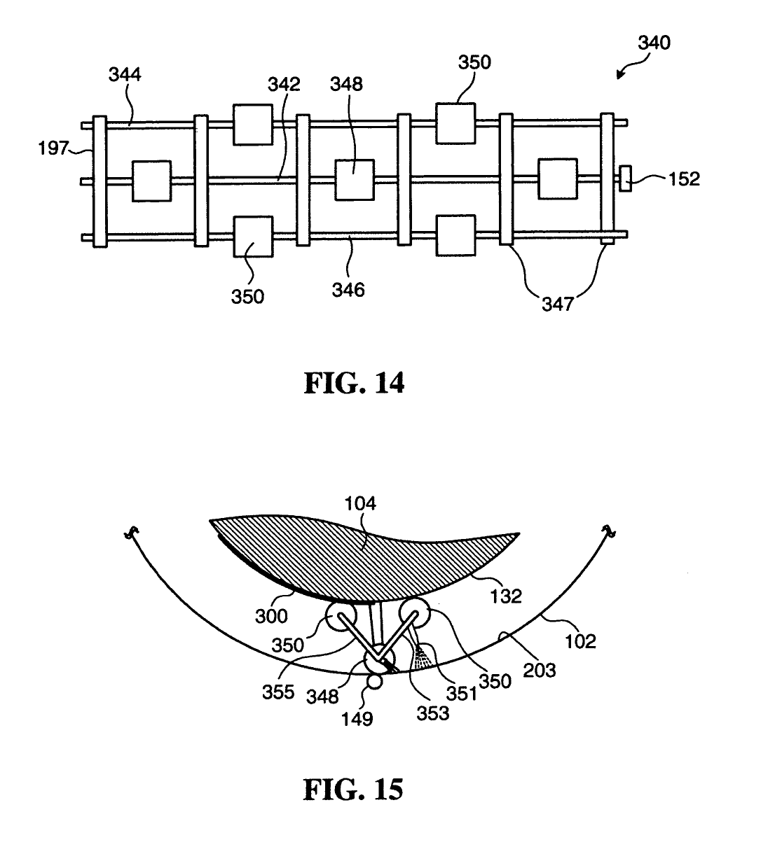

Referring to FIG. 14 and FIG. 15, an alternative embodiment of the trailing edge clamp 150 is shown at 340. The trailing edge clamp 340 includes a shaft 342, a first outer shaft 344, and a second outer shaft 346. The shafts 342, 344 and 346 are supported by cross members 347. A plurality of rollers 348 are located on the shaft 342 and a plurality of rollers 350 are located on the first and second outer shafts 344 and 346. The cross members 347 include a pair of arms 353 and 355, which are angled such that the rollers 350 are located in a common plane and the rollers 348 are located above the plane of the rollers 350. The rollers 348 bear on the wall 203 of the container 102 while the rollers 350 are biased into contact with the printing plate 300 by the cross members 347, which causes the trailing edge region 302 of the printing plate 300 to be clamped to the surface 132 of the drum 104. The trailing edge clamp 150 also includes a cleaning nozzle 351 for directing a jet of liquid or air towards the wall 203 of the container 102. Advantageously, since the trailing edge clamp 340 bears on the wall 203 of the container 102, the shaft 342 is supported by the wall and does not have to be as rigid as would be required without the support of the wall of the container. This allows the space between the drum 104 and the container 102 to be kept to a minimum, thus reducing the required volume of the container and the required amounts of liquid 116 needed to fill the container.

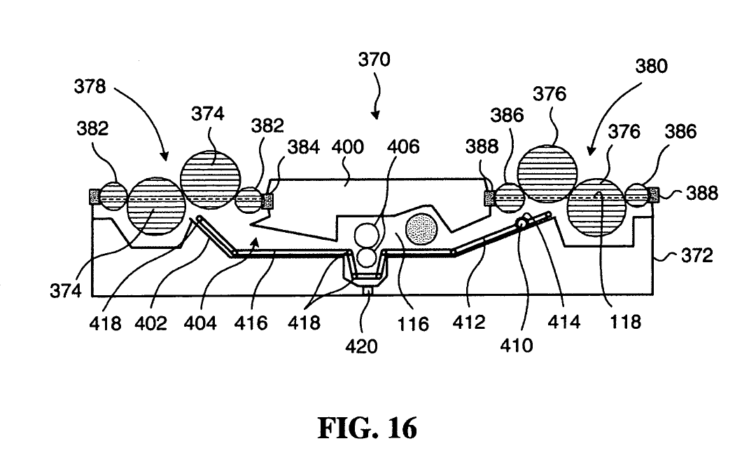

Referring to FIG. 16, an embodiment of a printing plate processor according to an alternative embodiment of the invention is shown generally at 370. The printing plate processor 370 includes a container 372 for containing the liquid 116 for performing the operation on the printing plate and a cover 400 for covering at least a portion of the container 372. The liquid 116 has a surface 118 indicated by the broken line across the container. The container 372 includes an entrance opening 378 and an exit opening 380, both being defined between the cover 400 and the container 372. The printing plate processor 370 also includes a pair of entrance transport rollers 374 located in the entrance opening 378 and a pair of exit transport rollers 376 located in the exit opening 380. The entrance transport rollers 374 are in contact with each other as are the exit transport rollers 376.

The printing plate processor 370 further includes a pair of entrance seal rollers 382 and a pair of compliant members 384, one of the compliant members 384 being sealingly attached to the container 372 and the other being sealing attached to the cover 400. The entrance seal rollers 382 each contact one of the entrance transport rollers 374 and one of the compliant members 384 to seal the entrance opening 378. Similarly the printing plate processor 370 includes a pair of exit seal rollers 386 and a pair of compliant members 388 for sealing the exit opening 380. The printing plate processor 370 also includes a guide 402 for guiding the printing plate through the container 372. The cover 400 may have complementarily shaped features to the guide 402, thus defining a path 404 through the container 372, between the entrance opening 378 and the exit opening 380.

The printing plate processor 370 also includes a pair of guide rollers 406 located partway between the entrance opening 378 and the exit opening 380. The printing plate processor 370 further includes a processor brush 408 located proximate to the guide rollers 406. The printing plate processor 370 further includes a cleaner 410 and a track 412. The cleaner 410 includes a brush 414 and is moveable along the track 412. The track 412 may include a continuous belt 416 and a plurality of sprockets 418. One of the sprockets 418 may include drive provisions for actuating the cleaner 410 to contact the elements to be cleaned.

The operation of the printing plate processor 370 is described in relation to FIG. 16. A printing plate is received at the entrance opening 378 and passes through the entrance transport rollers 374, one of which is a driven roller. The guide 402 guides the printing plate to the guide rollers 406, one of which may be a driven roller. The processor brush 408 brushes the plate to remove residues therefrom. The guide rollers 406 transport the printing plate towards the exit opening 380 where the printing plate is received by the exit transport rollers 376, and discharged from the exit opening 380. The entrance and the exit openings 378 and 380 are sealed to reduce interaction between the liquid 116 and air surrounding the container 372. The cleaner 410 is moveable along the track 414 and operates to dislodge residue from the guide 402, a drain 420, and the processor brush 408.

The printing plate processor 370 may further be provided with a circulation system and a liquid storage system as shown in relation to the printing plate processor 100, shown in FIG. 7.

While specific embodiments of the invention have been described and illustrated, such embodiments should be considered illustrative of the invention only and not as limiting the invention as construed in accordance with the accompanying claims.

What is claimed is:

1. An apparatus for cleaning an element used in a printing plate processor, the printing plate processor including a container for containing a liquid used in performing the processing operation on the printing plate, the apparatus comprising:
a cleaner located in the container, said cleaner being moveable to clean the element to be cleaned;
an actuator coupled to said cleaner and operably configured to move said cleaner to clean the element.

2. The apparatus of claim 1 wherein the printing plate processor further comprises an entrance operable to receive the printing plate into the liquid and an exit operable to discharge the printing plate from the liquid.

3. The apparatus of claim 2 wherein the container further comprises a guide operable to guide the printing plate from said entrance to said exit and wherein the element to be cleaned comprises said guide.

4. The apparatus of claim 2 wherein the container comprises a wall extending from said entrance to said exit and wherein the element to be cleaned comprises at least a portion of said wall.

5. The apparatus of claim 2 wherein at least one of said entrance and said exit comprises a roller and wherein the element to be cleaned comprises said roller.

6. The apparatus of claim 1 wherein the printing plate processor further comprises a brush operably configured to brush the printing plate to remove material that has been operated on by the liquid and wherein the element to be cleaned comprises said brush.

7. The apparatus of claim 1 wherein said cleaner comprises at least one of a brush, a wiper blade, a water jet and an air jet.

8. The apparatus of claim 1 further comprising a track operable to guide said cleaner to clean the element and wherein said actuator is operably configured to move said cleaner along said track.

9. The apparatus of claim 8 wherein said track is operably configured to guide said cleaner to clean more than one element.

10. The apparatus of claim 1 wherein the printing plate processor further comprises a rotateable drum operably configured to receive the printing plate on a surface of said drum and to convey the printing plate through the liquid.

11. The apparatus of claim 10 wherein the element to be cleaned comprises said drum.

12. The apparatus of claim 10 wherein said cleaner is coupled to said drum and said drum acts as said actuator.

13. The apparatus of claim 10 wherein the printing plate processor further comprises a brush operable to brush the printing plate to remove material that has been operated on by the liquid and wherein said brush is operably configured to clean said drum.

14. The apparatus of claim 13 wherein said cleaner and said brush are configured such that said cleaner and said brush are operable to move into contact each other to clean at least one of said brush and said cleaner.

15. The apparatus of claim 10 further comprising a clamp operable to clamp an edge of the printing plate to said drum and wherein said cleaner is coupled to said clamp, said drum being operable to move said clamp and said cleaner.

16. The apparatus of claim 1 wherein said cleaner is operable to dislodge residue from the element to be cleaned and wherein the container further comprises a drain for draining liquid from the container such that said residue is flushed out of the container.

17. The apparatus of claim 16 wherein the element to be cleaned comprises said drain.

18. The apparatus of claim 1 wherein the printing plate processor further comprises at least one sensor operably configured to produce an output, said output being representative of a condition of the liquid and wherein said cleaner is responsive to said output to clean the element when said output indicates that cleaning is required based on said condition of the liquid.

19. The apparatus of claim 16 wherein the container comprises an inlet for supplying liquid to the container and further comprising a pump, said pump being operable to cause a flow of liquid in the container between said inlet and said drain, said flow being operable to flush said residue out of the container.

20. The apparatus of claim 19 wherein said inlet is operably configured such that said flow is substantially uniform across the container.

21. The apparatus of claim 20 wherein said inlet comprises a plurality of inlet openings, said plurality of inlet openings being configured such that said flow is substantially uniform across the container.

22. The apparatus of claim 20 wherein said drain is operably configured such that said flow is substantially uniform across the container.

23. The apparatus of claim 22 wherein said drain comprises a plurality of outlet openings, said outlet openings being configured such that said flow is substantially uniform across the container.

24. The apparatus of claim 19 further comprising a filter operably configured to remove said residue from the liquid.

25. The apparatus of claim 19 wherein the printing plate processor is operable to convey the printing plate along a path through the liquid and said inlet and said drain are located such that a direction of said flow in the container is generally aligned with said path.

26. The apparatus of claim 25 wherein said inlet is a first inlet and said flow is a first flow and further comprising a second inlet operable to cause a second flow between said second inlet and said drain, said second inlet being located such that a direction of said second flow is generally aligned with said path and in a generally opposite direction to said first flow.

27. The apparatus of claim 25 comprising a plurality of inlets and a plurality of drains, said inlets and said drains being located to cause a plurality of counteracting flows generally aligned with said path.

28. The apparatus of claim 16 further comprising an inlet operably configured to permit a cleaning solvent to be delivered to the container, said cleaning solvent being operable to facilitate cleaning of said element.

29. The apparatus of claim 28 further comprising a storage reservoir for receiving liquid drained from the container.

30. The apparatus of claim 29 wherein the container comprises an inlet operable to supply liquid to the container and wherein said storage reservoir further comprises an outlet conduit connected to said inlet, said outlet conduit operable to re-introduce the liquid into the container from said storage reservoir after the cleaning of the element has been completed.

31. The apparatus of claim 30 wherein said storage reservoir further comprises an air inlet for receiving air having at least a portion of a constituent of air removed therefrom to reduce oxidation of the liquid in said storage reservoir.

32. The apparatus of claim 31 wherein said constituent of air comprises carbon dioxide.

33. The apparatus of claim 29 wherein said storage reservoir comprises an inlet for receiving liquid from a supply of liquid to replenish liquid that is wasted while draining the liquid out of the container.

34. The apparatus of claim 33 wherein said supply of liquid comprises a supply of concentrated liquid.

35. The apparatus of claim 34 wherein said storage reservoir comprises a drain outlet for removing at least a portion of the liquid before replenishing the liquid.

36. The apparatus of claim 28 wherein the container further comprises an inlet for adding an additive to the liquid before draining the liquid from the container.

37. The apparatus of claim 36 wherein said additive comprises a neutralizer and further comprising a pH sensor operable to generate a signal representing a pH level of the liquid and a valve operable to control addition of said neutralizer to the liquid in response to said signal.

38. An apparatus for cleaning an element used in a printing plate processor, the printing plate processor including a container for containing a liquid used in performing the processing operation on the printing plate, the apparatus comprising:
cleaning means for cleaning the element, said cleaning means being moveable to clean the element to be cleaned;
actuator means for moving said cleaning means to clean the element.

39. The apparatus of claim 38 wherein the printing plate processor further comprises an entrance for receiving the printing plate into the liquid and an exit for discharging the printing plate from the liquid.

40. The apparatus of claim 39 wherein the container further comprises guide means for guiding the printing plate from said entrance to said exit and wherein the element to be cleaned comprises said guide means.

41. The apparatus of claim 38 wherein the printing plate processor further comprises means for removing material from the printing plate that has been operated on by the liquid and wherein the element to be cleaned comprises said means for removing material.

42. The apparatus of claim 41 further comprising means for causing said means for removing material and said cleaning means to contact each other to effect cleaning of at least one of said means for removing material and said cleaning means.

43. The apparatus of claim 38 further comprising means for guiding said cleaner to clean the element.

44. The apparatus of claim 43 wherein said means for guiding comprises means for guiding said cleaner to clean more than one element.

45. The apparatus of claim 38 wherein the printing plate processor further comprises means for receiving the printing plate on a surface of a rotatable drum and drive means associated with said drum for conveying said drum and the printing plate through the liquid and wherein said cleaning means is coupled to said drum.

46. The apparatus of claim 45 further comprising clamping means for clamping an edge of the printing plate to said drum and wherein said cleaning means is coupled to said clamping means.

47. The apparatus of claim 38 wherein said cleaning means is operable to dislodge residue from the element to be cleaned and further comprising means for flushing residue out of the container.

48. The apparatus of claim 47 wherein the element to be cleaned comprises said means for flushing residue out of the container.

49. The apparatus of claim 47 further comprising means for circulating the liquid in said container and filter means for filtering said residues from the circulating liquid.

50. The apparatus of claim 49 wherein the printing plate processor comprises means for conveying the printing plate along a path through the liquid and said means for circulating the liquid comprises means for causing a flow of liquid in said container, said flow having a direction generally aligned with said path.

51. The apparatus of claim 50 wherein said flow is a first flow and further comprising means for causing a second flow of liquid in said container, said second flow having a direction generally aligned with said path and in a generally opposite direction to said first flow.

52. The apparatus of claim 50 further comprising means for causing a plurality of counteracting flows in said container.

53. The apparatus of claim 47 further comprising means for draining the liquid from the container and means for delivering a cleaning solvent to the container, said cleaning solvent being operable to facilitate cleaning of said element.

54. The apparatus of claim 53 further comprising a storage reservoir for receiving liquid drained from the container.

55. The apparatus of claim 54 further comprising means for re-introducing the liquid into the container from said storage reservoir after the cleaning of the element has been completed.

56. The apparatus of claim 54 wherein said storage reservoir comprises means for receiving liquid from a supply of liquid to replenish liquid that is wasted while draining the liquid out of the container.

57. The apparatus of claim 56 wherein said storage reservoir comprises means for removing at least a portion of the liquid before replenishing the liquid.

58. The apparatus of claim 53 wherein the container further comprises means for adding an additive to the liquid before draining the liquid from the container.

59. The apparatus of claim 58 wherein said additive comprises a neutralizer and further comprising means for generating a signal representing a pH level of the liquid and means for controlling addition of said neutralizer to the liquid in response to said signal.

60. The apparatus of claim 38 wherein the printing plate processor further comprises means for monitoring a condition of the liquid and means for causing said cleaning means to clean the element when said condition of the liquid indicates that cleaning is required.

61. In a printing plate processor, the printing plate processor including a container for containing a liquid used in performing the processing operation on the printing plate, a method for cleaning an element used in the plate processor, the method comprising:
causing an actuator to move a cleaner to clean the element to be cleaned.

62. The method of claim 61 wherein cleaning the element comprises cleaning a portion of a wall of the container.

63. The method of claim 61 wherein cleaning the element comprises cleaning a brush, said brush being operable to remove material from the printing plate that has been operated on by the liquid.

64. The method of claim 61 further comprising guiding said cleaner to clean the element.

65. The method of claim 64 comprising guiding said cleaner to clean more than one element.

66. The method of claim 61, further comprising coupling the cleaner to a drum for movement therewith, said drum operable to receive the printing plate on a surface thereof and to convey the printing plate through the liquid.

67. The method of claim 66 comprising coupling said cleaner to a clamp, said clamp operable to clamp an edge of the printing plate to said drum.

68. The method of claim 61 wherein said cleaner is operable to dislodge residue from the element to be cleaned and further comprising flushing residue out of the container.

69. The method of claim 68 wherein flushing residue out of the container comprises flushing residue out of the container through a drain in the container and wherein cleaning the element comprises cleaning said drain.

70. The method of claim 68 further comprising circulating the liquid in said container and filtering said residues from the circulating liquid.

71. The method of claim 70 further comprising conveying the printing plate along a path through the liquid and wherein circulating the liquid comprises causing a flow of liquid in said container, said flow having a direction generally aligned with said path.

72. The method of claim 71 wherein said flow is a first flow and further comprising causing a second flow of liquid in said container, said second flow having a direction generally aligned with said path and in a generally opposite direction to said first flow.

73. The method of claim 68 further comprising draining at least a portion of the liquid from the container and delivering a cleaning solvent to the container, said cleaning solvent being operable to facilitate cleaning of said element.

74. The method of claim 73 further comprising receiving liquid drained from the container in a storage reservoir.

75. The method of claim 74 further comprising removing at least a portion of a constituent of air from air in the storage reservoir.

76. The method of claim 74 further comprising re-introducing the liquid into the container from said storage reservoir after the cleaning of the element has been completed.

77. The method of claim 74 further comprising receiving liquid from a supply of liquid in said storage reservoir to replenish liquid that is wasted while draining the liquid out of the container.

78. The method of claim 77 further comprising removing at least a portion of the liquid before replenishing the liquid.

79. The method of claim 73 further comprising adding an additive to the liquid before draining the liquid from the container.

80. The method of claim 79 wherein adding said additive comprises adding a neutralizer to the liquid and further comprising generating a signal representing a pH level of the liquid and controlling addition of said neutralizer to the liquid in response to said signal.

81. The method of claim 61 further comprising monitoring a condition of the liquid and causing said cleaner to clean the element when said condition of the liquid indicates that cleaning is required.

82. An apparatus for performing a processing operation on a printing plate, the apparatus comprising:
a container operably configured to contain a liquid for use in performing the processing operation on the printing plate;
a cover operably configured to cover a surface of said liquid in said container to reduce interaction between said liquid and an environment about said container, said cover defining an entrance opening operably configured to admit the printing plate into said liquid and an exit opening operably configured to permit the printing plate to be discharged from said liquid;
an entrance seal operably configured to seal said entrance opening to reduce interaction between said liquid and said environment through said entrance opening and to permit the printing plate to pass through said entrance opening into said liquid;
an exit seal operably configured to seal said exit opening to reduce interaction between said liquid and said environment through said exit opening and to permit the printing plate to pass through said exit opening when being discharged from said liquid;
said container being operably configured to contain said liquid such that said surface of said liquid is at or below said entrance seal and said exit seal and such that substantially no head of liquid bears on said entrance and said exit seals.

83. The apparatus of claim 82 wherein said entrance seal and said exit seal are operable to reduce interaction between said liquid and said environment while the printing plate is passing through said entrance and said exit openings.

84. The apparatus of claim 83 wherein at least one of said entrance seal and said exit seal comprises a first roller having a first cylindrical surface and a second roller having a second cylindrical surface, said first cylindrical surface and said second cylindrical surface being in contact and defining a nip seal between said first cylindrical surface and said second cylindrical surface.

85. The apparatus of claim 84 further comprising an end seal operable to seal an end of at least one of said first roller and said second roller, said end seal comprising a slip disk and a compliant disk, said compliant disk being located between said end of said roller and said slip disk and being operably configured to bias said slip disk into contact with a sidewall of said container, thereby sealing said end of said roller while permitting rotation of said roller.

86. The apparatus of claim 84 wherein at least one of said first roller and said second roller comprises a driven roller operably configured to advance said printing plate through said nip seal into or out of said liquid.

87. The apparatus of claim 82 wherein said container is operably configured to contain said liquid such that a space is defined between said surface of said liquid and at least one of said entrance seal and said exit seal and further comprising an inlet for delivering a gas into said space, said gas operable to reduce interaction between said liquid and said environment.

88. The apparatus of claim 82 further comprising a guide operable to guide the printing plate through said liquid from said entrance opening to said exit opening.

89. The apparatus of claim 88 wherein said guide comprises at least one roller located between said entrance opening and said exit opening.

90. The apparatus of claim 82, wherein said cover comprises a rotateable drum operably configured to receive the printing plate on a surface of said drum and to convey the printing plate through said liquid from said entrance opening to said exit opening.

91. The apparatus of claim 90 wherein at least one of said entrance seal and said exit seal comprises a roller located in said entrance opening or said exit opening, said roller having a cylindrical surface operably configured to contact said drum to define a nip seal between said cylindrical surface and said surface of said drum.

92. The apparatus of claim 90 further comprising a load roller operable to cause the printing plate to be forced into close contact with said surface of said drum thereby reducing interaction between said liquid and a surface of the printing plate in contact with said drum.

93. The apparatus of claim 90 further comprising a leading edge clamp operable to clamp a leading edge of the printing plate to said surface of said drum.

94. The apparatus of claim 93 wherein said leading edge clamp comprises a moveable member configured to fit complementarily into a recess in said surface of said drum thereby reducing carry out of liquid through said exit seal, said moveable member being operable to clamp said leading edge between said moveable member and a surface of said recess.

95. The apparatus of claim 93 further comprising a trailing edge clamp operable to apply a retaining force to a trailing edge region of the printing plate to retain said trailing edge region of the printing plate in contact with said surface of said drum.

96. The apparatus of claim 95 further comprising a support member coupled to said leading edge clamp, said support member operably configured to bear on a wall of said container thereby augmenting said retaining force.

97. The apparatus of claim 95 wherein said trailing edge clamp is operably configured to move independently of said drum to facilitate movement of said trailing edge clamp with respect to said drum while the printing plate is being subjected to a processing operation thereby preventing masking of a portion of the trailing edge region of the printing plate.

98. The apparatus of claim 95 wherein said trailing edge clamp is operably configured to retain said trailing edge region of the printing plate after said leading edge of the printing plate has passed through said entrance opening into said liquid.

99. The apparatus of claim 95 further comprising a cleaner coupled to said trailing edge clamp and moveable therewith, said cleaner being operable to contact an element to be cleaned in said container.

100. The apparatus of claim 99 wherein said element is at least one of:
said entrance seal;
said exit seal;
said drum;
said leading edge clamp;
a wall of said container;
a drain operable to drain liquid from said container; or
a brush operable to remove material from the printing plate acted on by said liquid.

101. The apparatus of claim 82, further comprising a brush operable to remove material from the printing plate acted on by the liquid, said brush being located proximate said exit opening such that a substantial portion of material removed by said brush is directed downwardly in a direction away from said exit seal.

102. The apparatus of claim 82 wherein said exit seal is operably configured such that when the printing plate is discharged from said liquid the printing plate is in a generally vertical orientation thereby reducing carry out of the liquid through said exit seal.

103. The apparatus of claim 82 further comprising a heater operable to raise a temperature of the liquid above a temperature of said environment about said container thereby increasing activity of the processing operation.

104. An apparatus for performing a processing operation on a printing plate, the apparatus comprising:
a container operably configured to contain a liquid for use in performing the processing operation on the printing plate;
means for covering a surface of said liquid in said container to reduce interaction between said liquid and an environment about said container, said means for covering defining an entrance opening for admitting the printing plate into said liquid and an exit opening for permitting the printing plate to be discharged from said liquid;
entrance seal means for sealing said entrance opening to reduce interaction between said liquid and said environment through said entrance opening and to permit the printing plate to pass through said entrance opening into said liquid;
exit seal means for sealing said exit opening to reduce interaction between said liquid and said environment through said exit opening and to permit the printing plate to pass through said exit opening when being discharged from said liquid;
said container being operably configured to contain said liquid such that said surface of said liquid is at or below said entrance seal means and said exit seal means and such that substantially no head of liquid bears on said entrance seal means and said exit seal means.

105. The apparatus of claim 104 wherein said entrance seal means and said exit seal means comprise means for reducing interaction between said liquid and said environment while the printing plate is passing through said entrance and said exit openings.

106. The apparatus of claim 105 wherein at least one of said entrance seal means and said exit seal means comprises means for defining a nip seal for sealing said entrance or said exit opening, said nip seal operable to permit the printing plate to pass therethrough while reducing interaction between said liquid and said environment.

107. The apparatus of claim 106 wherein said means for defining said nip seal is operable to advance said printing plate through said nip seal into or out of said liquid.

108. The apparatus of claim 104 wherein said container is operably configured to contain said liquid such that a space is defined between said surface of said liquid and at least one of said entrance seal means and said exit seal means and further comprising means for delivering a fluid into said space, said fluid operable to reduce interaction between said liquid and said environment.

109. The apparatus of claim 104 further comprising guide means for guiding the printing plate through said liquid from said entrance opening to said exit opening.

110. The apparatus of claim 104, wherein said means for covering comprises a rotateable drum having means for receiving the printing plate on a surface of said drum and means for conveying the printing plate through said liquid from said entrance opening to said exit opening.

111. The apparatus of claim 110 wherein at least one of said entrance seal means and said exit seal means comprises means for defining a nip seal between said entrance opening or said exit opening and said surface of said drum.

112. The apparatus of claim 110 further comprising means for causing the printing plate to be forced into close contact with said surface of said drum thereby reducing interaction between said liquid and a surface of the printing plate in contact with said drum.

113. The apparatus of claim 110 further comprising leading edge clamping means for clamping a leading edge of the printing plate to said surface of said drum.

114. The apparatus of claim 113 further comprising trailing edge clamping means for applying a retaining force to a trailing edge region of the printing plate to retain said trailing edge region of the printing plate in contact with said surface of said drum.

115. The apparatus of claim 114 wherein said trailing edge clamping means comprises means for facilitating movement of said trailing edge clamp with respect to said drum while the printing plate is being subjected to a processing operation thereby preventing masking of a portion of the trailing edge region of the printing plate.

116. The apparatus of claim 114 wherein said trailing edge clamping means comprises means for retaining said trailing edge region of the printing plate after said leading edge of the printing plate has passed through said entrance opening into said liquid.

117. The apparatus of claim 114 further comprising cleaner means for cleaning an element, said cleaner means being coupled to said trailing edge clamping means and moveable therewith, said cleaner means being operable to contact the element to be cleaned in said container.

118. The apparatus of claim 104, further comprising a means for removing material from the printing plate acted on by the liquid, said means for removing being located proximate said exit opening such that a substantial portion of material removed by said means for removing is directed downwardly in a direction away from said exit seal means.

119. The apparatus of claim 104 wherein said exit seal means comprises means for discharging the printing plate from said liquid in a generally vertical orientation thereby reducing carry out of the liquid through said exit seal means.

120. The apparatus of claim 104 further comprising means for raising a temperature of the liquid above a temperature of said environment about said container thereby increasing activity of the processing operation.

121. An method for performing a processing operation on a printing plate in a container operably configured to contain a liquid for use in performing the processing operation on the printing plate; the method comprising:
covering a surface of the liquid in the container to reduce interaction between the liquid and an environment about the container;
sealing an entrance opening to the container such that substantially no head of liquid bears on said sealed entrance opening, said sealing being operable to reduce interaction between the liquid and said environment through said entrance opening and to permit the printing plate to pass through said entrance opening into the liquid;
sealing an exit opening to said container such that substantially no head of liquid bears on said sealed exit opening, said sealing operable to reduce interaction between the liquid and said environment through said exit opening and to permit the printing plate to pass through said exit opening when being discharged from the liquid.

122. The method of claim 121 wherein sealing said entrance and sealing said exit comprises sealing said exit and said entrance such that interaction between the liquid and said environment is reduced while the printing plate is passing through said entrance and said exit openings.

123. The method of claim 121 further comprising introducing a fluid into a space between a surface of the liquid and said entrance opening and said exit opening, said fluid operable to reduce interaction between the liquid and said environment.

124. The method of claim 121 further comprising guiding the printing plate through the liquid from said entrance opening to said exit opening.

125. The method of claim 121, wherein covering the container comprises covering the container using a rotateable drum, said rotateable drum being operable to receive the printing plate on a surface of said drum and to convey the printing plate through the liquid from said entrance opening to said exit opening.

126. The method of claim 125 further comprising causing the printing plate to be forced into close contact with said surface of said drum thereby reducing interaction between the liquid and a surface of the printing plate in contact with said drum.

127. The method of claim 125 further comprising clamping a leading edge of the printing plate to said surface of said drum.

128. The method of claim 127 further comprising applying a retaining force to a trailing edge region of the printing plate to retain said trailing edge region of the printing plate in contact with said surface of said drum.

129. The method of claim 128 wherein applying a retaining force to a trailing edge region of the printing plate comprises retaining said trailing edge region of the printing plate after said leading edge of the printing plate has passed through said entrance opening into the liquid.

130. The method of claim 121 comprising discharging the printing plate from the liquid in a generally vertical orientation thereby reducing carry out of the liquid through said exit seal means.

131. The method of claim 121 further comprising raising a temperature of the liquid above a temperature of said environment about the container thereby increasing activity of the processing operation.
